(19) United States
(12) Patent Application Publication
(10) Pub. No.: US 2010/0122312 A1
(43) Pub. Date: May 13, 2010

(54) PREDICTIVE SERVICE SYSTEMS

(75) Inventors: Tammy Green, Provo, UT (US); Jon Bultmeyer, Dorchester, MA (US); Stephen R. Carter, Spanish Fork, UT (US); Scott Alan Isaacson, Kamuela, HI (US)

Correspondence Address: MARGER JOHNSON & MCCOLLOM, P.C. - NOVELL, 210 SW MORRISON STREET, SUITE 400, PORTLAND, OR, 97204, US

(73) Assignee: Novell, Inc., Provo, UT (US)

(21) Appl. No.: 12/267,279

(22) Filed: Nov. 7, 2008

(51) Int. Cl. G06N 5/00; G06F 21/00

(52) U.S. Cl. 726/1; 706/46

(57) ABSTRACT

A predictive service system can include a gathering service to gather user information, a semantic service to generate a semantic abstract for the user information, a policy service to enforce a policy, and a predictive service to act on an actionable item that is created based on the user information, the semantic abstract, and the policy. The system can also include an analysis module to create the actionable item and send it to the predictive service. The system can also include an identity service to create a crafted identity for the user.

### CROSS-REFERENCE TO RELATED APPLICATIONS

This application is related to co-pending and commonly owned U.S. patent application Ser. No. 11/929,678, titled “CONSTRUCTION, MANIPULATION, AND COMPARISON OF A MULTI-DIMENSIONAL SEMANTIC SPACE,” filed on Oct. 30, 2007, which is a divisional of U.S. patent application Ser. No. 11/562,337, filed on Nov. 21, 2006, which is a continuation of U.S. patent application Ser. No. 09/512,963, filed Feb. 25, 2000, now U.S. Pat. No. 7,152,031, issued on Dec. 19, 2006. All of the foregoing applications are fully incorporated by reference herein.

This application is also related to co-pending and commonly owned U.S. patent application Ser. No. 11/616,154, titled “SYSTEM AND METHOD OF SEMANTIC CORRELATION OF RICH CONTENT,” filed on Dec. 26, 2006, which is a continuation-in-part of U.S. patent application Ser. No. 11/563,659, titled “METHOD AND MECHANISM FOR THE CREATION, MAINTENANCE, AND COMPARISON OF SEMANTIC ABSTRACTS,” filed on Nov. 27, 2006, which is a continuation of U.S. patent application Ser. No. 09/615,726, filed on Jul. 13, 2000, now U.S. Pat. No. 7,197,451, issued on Mar. 27, 2007; and is a continuation-in-part of U.S. patent application Ser. No. 11/468,684, titled “WEB-ENHANCED TELEVISION EXPERIENCE,” filed on Aug. 30, 2006; and is a continuation-in-part of U.S. patent application Ser. No. 09/691,629, titled “METHOD AND MECHANISM FOR SUPERPOSITIONING STATE VECTORS IN A SEMANTIC ABSTRACT,” filed on Oct. 18, 2000, now U.S. Pat. No. 7,389,225, issued on Jun. 17, 2008; and is a continuation-in-part of U.S. patent application Ser. No. 11/554,476, titled “INTENTIONAL-STANCE CHARACTERIZATION OF A GENERAL CONTENT STREAM OR REPOSITORY,” filed on Oct. 30, 2006, which is a continuation of U.S. patent application Ser. No. 09/653,713, filed on Sep. 5, 2000, now U.S. Pat. No. 7,286,977, issued on Oct. 23, 2007. All of the foregoing applications are fully incorporated by reference herein.

This application is also related to co-pending and commonly owned U.S. patent application Ser. No. 09/710,027, titled “DIRECTED SEMANTIC DOCUMENT PEDIGREE,” filed on Nov. 7, 2000, which is fully incorporated by reference herein.

This application is also related to co-pending and commonly owned U.S. patent application Ser. No. 11/638,121, titled “POLICY ENFORCEMENT VIA ATTESTATIONS,” filed on Dec. 13, 2006, which is a continuation-in-part of U.S. patent application Ser. No. 11/225,993, titled “CRAFTED IDENTITIES,” filed on Sep. 14, 2005, and is a continuation-in-part of U.S. patent application Ser. No. 11/225,994, titled “ATTESTED IDENTITIES,” filed on Sep. 14, 2005. All of the foregoing applications are fully incorporated by reference herein.

This application also fully incorporates by reference the following commonly owned patents: U.S. Pat. No. 6,108,619, titled “METHOD AND APPARATUS FOR SEMANTIC CHARACTERIZATION OF GENERAL CONTENT STREAMS AND REPOSITORIES,” U.S. Pat. No. 7,177,922, titled “POLICY ENFORCEMENT USING THE SEMANTIC CHARACTERIZATION OF TRAFFIC,” and U.S. Pat. No. 6,650,777, titled “SEARCHING AND FILTERING CONTENT STREAMS USING CONTOUR TRANSFORMATIONS,” which is a divisional of U.S. Pat. No. 6,459,809.

### TECHNICAL FIELD

The disclosed technology pertains to predictive services, and more particularly to implementations of predictive services in conjunction with gathering services, semantic services, identity services, and policy services.

### BACKGROUND

U.S. Pat. No. 7,152,031, titled “CONSTRUCTION, MANIPULATION, AND COMPARISON OF A MULTI-DIMENSIONAL SEMANTIC SPACE,” describes a method and apparatus for mapping terms in a document into a topological vector space. Determining what documents are about requires interpreting terms in the document through their context. Although taking a term in the abstract will generally not give the reader much information about the content of a document, taking several important terms will usually be helpful in determining content.

U.S. patent application Ser. No. 11/563,659, titled “METHOD AND MECHANISM FOR THE CREATION, MAINTENANCE, AND COMPARISON OF SEMANTIC ABSTRACTS,” describes creating a semantic abstract for a document. If a user is interested in receiving a second content similar to a first content, for example, a semantic abstract can be created for the first content and then used to identify a second content that has a similar semantic abstract.

U.S. Pat. No. 6,650,777, titled “SEARCHING AND FILTERING CONTENT STREAMS USING CONTOUR TRANSFORMATIONS,” describes tools and techniques for identifying and classifying objects within a non-textual content stream and using contour transformations to obtain semantic values for non-textual objects within a content stream. For example, an object finder can be used to locate interesting objects (e.g., data set feature(s)) within a given content stream. When something of particular interest is located, an object transformer can transform the data set within the content stream and assign to it a semantically meaningful value (or values). The values can then be used to determine the object's identity relative to a dictionary of archetypes. Further refinement of the dictionary of archetypes and of the objects can be done using an object qualifier, which itself contains qualifier characteristics.

However, a need remains for a way to correlate the vast multitude of user and/or collaboration content (e.g., documents and/or events) in order to enable a predictive service to provide meaningful recommendations, hints, tips, etc. to the user or group of users (e.g., collaboration group) and, in some cases, take action based on the recommendations, hints, tips, etc. with or without user and/or collaboration authorization.

### SUMMARY

Embodiments of the disclosed technology can include a predictive services system operable to gather information about a user from user documents, analyze the gathered information to understand the user, and make one or more predictions about what the user would like to do given a certain set of circumstances.

In certain embodiments, a predictive service system can include a gathering service operable to collect information (e.g., documents and/or events) and store the information in a data store.

The predictive service system can also include a semantic service operable to evaluate the collected information in order to produce actionable items. For example, the semantic service can create semantic abstracts based on a document boundary (such as a paragraph, header, or page for a document, or a HTML page for an Internet application, depending on the content involved). These semantic abstracts can be placed into semantic space and distances between the semantic abstracts can be measured for use by a predictive service, as described below.

The predictive service system can also include a predictive service that is operable to act on the actionable items (e.g., user preferences and/or behavior based on the semantic abstracts, for example) in order to provide a user or collaboration group (e.g., group of users) with particular events, hints, recommendations, etc. The predictive service can also create events, conduct business on behalf of the user, and perform certain actions such as arrange travel, delivery, etc. to expedite approved events.

Working in conjunction with each other, the semantic service and the predictive service can “learn” about a user or a group of users based on information provided directly and/or indirectly to the predictive service system. The predictive service is operable to correlate the “learned” information to generate the events, hints, recommendations, etc. In general, each additional learning opportunity provided to the predictive service increases the ability of the predictive service to establish one or more patterns.

The foregoing and other features, objects, and advantages of the invention will become more readily apparent from the following detailed description, which proceeds with reference to the accompanying drawings.

### BRIEF DESCRIPTION OF THE DRAWINGS

FIGS. 1A-B show an example of a method for creating a crafted identity in accordance with embodiments of the disclosed technology.

FIG. 2 shows an example of a data structure representing a crafted identity in accordance with embodiments of the disclosed technology.

FIG. 3 shows an example of a predictive service system having a gathering service, a semantic service, a predictive service, and an analysis module in accordance with embodiments of the disclosed technology.

FIG. 4 shows an example of a gathering service that can interactively access and gather content, events, etc. from a wide variety of sources, such as user documents, user events, and user content flow.

FIG. 5 shows an example of a gathering service that can interactively access and gather content, events, etc. from collaboration documents, collaboration events, and collaboration content flow.

FIG. 6 shows an example of a gathering service that can interactively access and gather content from private content, world content, and restricted content.

FIG. 7 shows a flowchart illustrating an example of a method of constructing a directed set.

FIG. 8 shows a flowchart illustrating an example of a method of adding a new concept to an existing directed set.

FIG. 9 shows a flowchart illustrating an example of a method of updating a basis, either by adding to or removing from the basis chains.

FIG. 10 shows a flowchart illustrating an example of a method of updating a directed set.

FIG. 11 shows a flowchart illustrating an example of a method of using a directed set to refine a query.

FIG. 12 shows a flowchart illustrating an example of a method of constructing a semantic abstract for a document based on dominant phrase vectors.

FIG. 13 shows a flowchart illustrating an example of a method of constructing a semantic abstract for a document based on dominant vectors.

FIG. 14 shows a flowchart illustrating an example of a method of comparing two semantic abstracts and recommending a second content that is semantically similar to a content of interest.

FIG. 15 illustrates an exemplary user scenario in which a user receives a notification of a travel itinerary received into the user's user documents via an external agent.

FIG. 16 illustrates an exemplary user scenario in which an itinerary has been previously established for a user.

FIG. 17 illustrates an exemplary user scenario involving a user that enjoys Operas.

FIG. 18 illustrates an exemplary user scenario involving a user that enjoys fink music.

FIG. 19 illustrates an exemplary user scenario involving a user that maintains several blogs.

FIG. 20 illustrates an exemplary user scenario involving the creation of an RSS feed for a mailing list.

### DETAILED DESCRIPTION

Today, companies such as Amazon, Overstock, Barnes & Noble, and Netflix provide limited automations on their web sites that can provide, for example, recommendations for certain items for purchase or rental based on the purchase and/or rental history of the user, the user's profile, and data about the purchase and/or rental habits of other users. However, these automations are limited to a specific context and can only make mere suggestions.

Reginald Jeeves, a fictional character in many stories by P. G. Wodehouse, is an almost super-human valet who, having unnatural access to knowledge and an ability to correlate observations with such knowledge, is able to predict and fulfill his employer Bertie Wooster's every need. For example, whenever Wooster needs tickets to the theater, Jeeves would already have them in his pocket. Whenever Wooster needs reservations, Jeeves would have already made sure that the reservations are in place. Even bets on the race track are flawlessly placed thanks to the knowledge and foresight of Jeeves. However, in combining a correlation of events with the massive amount of Internet content, predictive services in accordance with the disclosed technology can actually outdo Jeeves in real life.

Embodiments of the disclosed technology can advantageously provide a user and/or group of users with predictive services to provide, for example, a wide variety of suggestions, recommendations, and even offers based on the immense content of the Internet as well as various events, desires, and habits of the user and/or group. Such predictive services can desirably act on information gathered and correlations made to provide better service. Embodiments of the disclosed technology can include “learning” appropriate behavior based on interactions with a user and/or group of users.

In certain embodiments of the disclosed technology, a policy service can be used to interpret a policy in order to constrain certain actions and activities, for example. A user can be provided with external access to and influence over such a policy service. However, such access and influence is generally governed by a policy to prevent unauthorized activities, for example.

In certain embodiments, user requests can be validated based on a certain policy. For example, if a user in a collaboration wants to modify a particular document but does not have rights to do (e.g., based on a policy), the policy service can deny the user's request to modify it but can allow the user to read it.

### Exemplary Identity Services and Policy Services

As used herein, a crafted identity generally refers to an identity that can permit the true identity of a principal (e.g., a specific type of resource, such as an automated service or user that acquires an identity) to remain anonymous from the resource it seeks to access. With a crafted identity, an identity vault (e.g., one or more repositories holding secrets and identifiers) can be opened to create the crafted identity and authenticate the principal to which it is associated, after which the identity vault can be closed. Thereafter, the crafted identity can be validated by a resource (e.g., a service, system, device, directory, data store, user, groups of users, combinations of these things, etc.), and acted upon without ever re-referencing the identity vault.

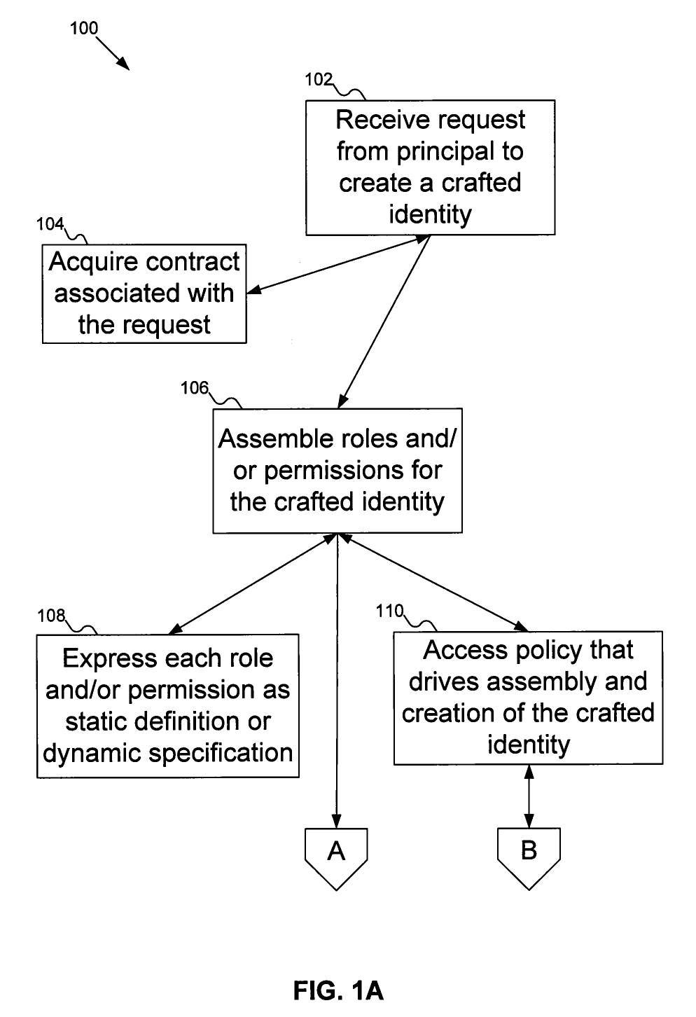

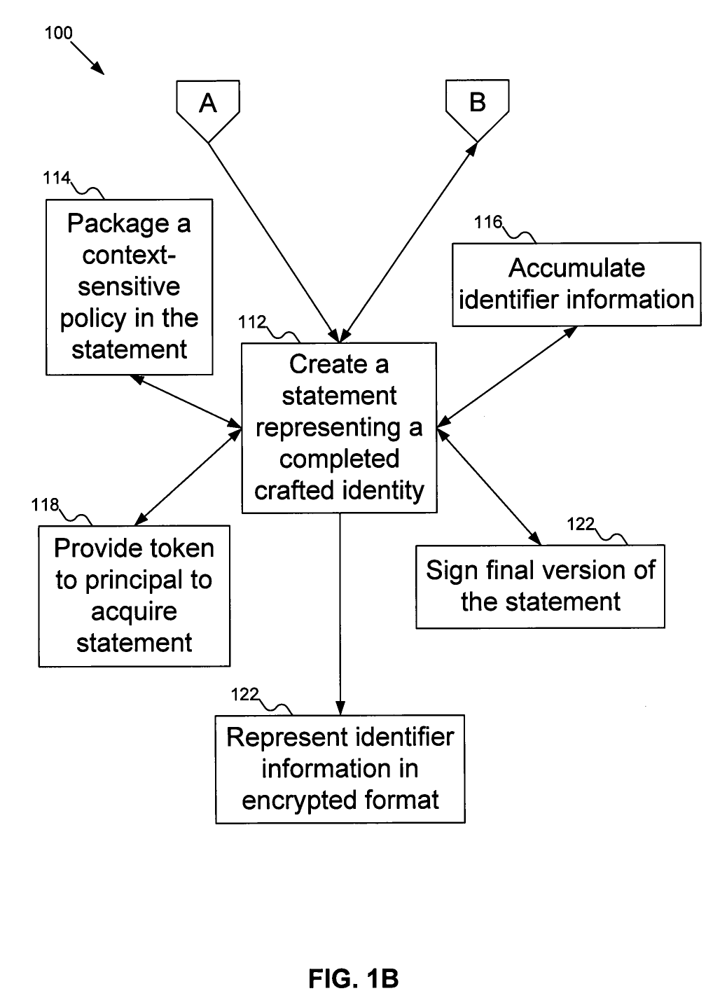

FIGS. 1A-B show an example of a method referred to as a creation service 100 for creating a crafted identity in accordance with embodiments of the disclosed technology. The creation service 100 can be implemented in a tangible, machine-readable medium, for example. The creation service can create a crafted identity on behalf of a principal requestor.

A principal (e.g., any type of resource making a request for a crafted identity, such as a user, a group of users, and an automated service), generally authenticates to the creation service 100 when requesting a crafted identity. That is, the creation service 100 and the principal are in a trusted relationship with one another and can communicate with one another securely. Also, the creation service 100 has access to identifiers and secrets of the principal, which are directed to the true identity of the principal. The secure communication is generally directed toward establishing a crafted identity and, within this context, the creation service 100 validates identifiers of the principal to assure the creation service 100 of the identity of the principal for the context.

The creation service 100 can receive a request from a principal to create a crafted identity, as shown at 102. Once created, such a crafted identity can advantageously preserve the anonymity of the principal and thereby prevent resources from accessing information about the principal, except for information that is included within the crafted identity.

The creation service 100 can acquire a contract associated with the request for the crafted identity, as shown at 104. The contract typically identifies or defines certain policies that are enforced during creation of the crafted identity. The contract may also identity the type of crafted identity to be created.

It should be noted that the principal may actually be authenticated to the creation service after a creation request for a crafted identity is received or during receipt of a request. Thus, the timing of the authentication can occur prior to the request, with a request, and/or after a request is received and has began to be processed by the creation service. Additionally, the authentication may include, but is not limited to, challenges from the creation service to the principal for passwords, smart token responses, responses requiring associated private keys, biometric responses, challenges for other identifiers or secret information, temporal constraints, etc.

The creation service 100 can assemble roles (e.g., designations recognized within the context of a given resource, such as administrator, supervisor, and visitor) and/or permissions (e.g., access rights for a given role on a given resource, such as read access, write access, and read/write access) for the crafted identity, as shown at 106. The crafted identity may be directed to providing anonymous access for the requesting principal to one or more resources for defined purposes that are enumerated or derivable from the initial request. In this regard, policies drive the roles and/or permissions represented in the crafted identity, which can combine to form access rights to a specific resource. Such policies may be dictated by the specific resource.

The roles and/or permissions can be expressed as a static definition or a dynamic specification, as shown at 108. A static definition can be predefined for a given role. Thus, resolution of permissions for a given role are typically fully calculated and declared once assembled for the crafted identity. Conversely, the roles and/or permissions can be expressed within a specification associated with the crafted identity. The specification can be evaluated on a given local system in a given local environment of a target resource to determine the roles and/or permissions dynamically and at runtime. A dynamic approach can permit roles/or and permissions to be dynamically resolved based on a given context or situation. That is, such roles and/or permissions can be provisionally defined within the crafted identity and resolved within a given context at runtime.

The creation service 100 can access one or more policies that drive the assembly and creation of the crafted identity and its associated information, as shown at 110. A policy can dictate what is included and what is not included in the crafted identity and related information. A statement or related information representing a competed crafted identity can be created, as shown at 112. The roles and/or permissions, attributes, and identifier information for the newly created crafted identity can be packed in a format defined by a policy or other specification.

Policies can be interpreted by a policy service, which can aggregate information with an identity (e.g., that may include a company name or a role) and also with information about whatever resource is being accessed. Policy enforcement points (PEPs) can be used to create a disposition on whether or not something should happen (e.g., using identity an input parameter). Also, certain requests can be validated by a policy, as discussed below.

The creation service 100 can separately interact with one or more resources that are associated with the crafted identity and thereby register the crafted identity with those resources. The creation service 100 can also include a modified identity service that has access to a pool of existing identities for the resources and is authorized to distribute them. The creation service 100 can also include validating service for the resources.

The creation service 100 can package a context-sensitive policy in the statement, as shown at 114. The context-sensitive policy can permit the crafted identity to be managed from different environments based on the context. Certain context-sensitive policies can permit the principal to determine access rights based on the contexts or environments within which the desired resource is being accessed by the principal having the crafted identity.

The creation service 100 can accumulate identifier information from a variety of identity vaults or identifier repositories, as shown at 116. The identifier information can include attributes concerning the principal that, according to a policy, are to be exposed in the crafted identity. The resource can use these attributes to validate the crafted identity. The identifier information can include a key, a signature of the creation service, and/or a certificate, for example. The identifier information typically prevents the resource validating from acquiring additional identifier information about the principal. Once the resource validates the crafted identity presented by the principal, the principal can assume the crafted identity within the context of accessing the resource and can desirably remain anonymous to the resource. Thus, the resource is assured that it is dealing with a legitimate and uncompromised identity.

The creation service 100 can maintain and manage the crafted identity. For example, a statement can be provided to the principal on an as-needed or dynamic basis whenever the principal desires to use it to access a given resource. Rather than directly providing the statement representing the crafted identity to the principal, the creation service can provide a token to the principal such that the principal can acquire the statement when desired using the token, as shown at 118.

The creation service 100 can represent the identifier information of the crafted identity that is included in the statement in an encrypted format, as shown at 120, so as to prevent is interception or unauthorized use, for example. As discussed above, the identifier information can include key information such as certificates and signatures. The statement generally represents a final expression of the crafted identity.

The creation service 100 can sign the final version of a statement that represents the crafted identity, as shown at 122. This digital signature can serve as an assertion to the authenticity of the crafted identity for other services, principals, and/or resources that trust the creation service 100. The statement can also be signed by the principal receiving it or by a principal service.

Once the creation service 100 has created the crafted identity for the principal and has included a mechanism for the principal to acquire and access the statement representing the crafted identity, the principal can advantageously use the information within the statement to securely and anonymously access a desired resource for which the crafted identity was created. Since a single crafted identity can include identifier information that can be validated and used with more than one desired resource, a single crafted identity and statement can combine to provide a requesting principal with anonymous access to a multitude of different resources.

The creation service 100 can associate constraints with any provided crafted identity or portion thereof. Such constraints can include a time-to-live or an event such that, when detected, the crafted identity (or portion thereof) can be revoked or invalidated. A policy can also constrain the crafted identity. Such a policy can monitor the usage and access of the principal and revoke the crafted identity upon detected misuse. Thus, the creation service can actively and dynamically manage the crafted identity.

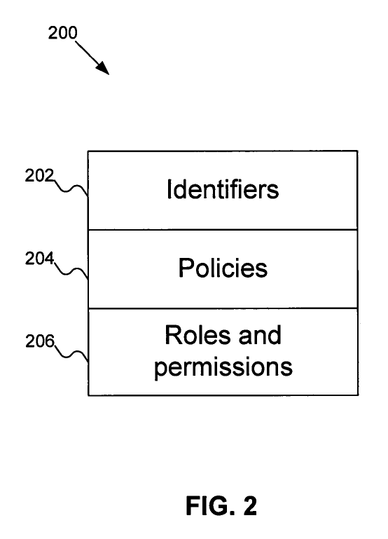

FIG. 2 shows an example of a data structure 200 representing a crafted identity in accordance with embodiments of the disclosed technology. The data structure 200 can be implemented in a tangible, machine-readable medium, for example. The data structure 200 can include one or more identifiers 202, one or more policies 204, and one or more roles and/or permissions 204. The data structure 200 can also include attribute information or other information that may prove useful to the principal in anonymously accessing the desired resources and to the creation or identity service in maintaining and managing the data structure 200.

The identifiers 202 can be created by a creation service or an identity service, such as the creation service 100 of FIGS. 1A-B. The identifiers 202 can be presented by principal services on behalf of principals to validate the crafted identity for access to a given resource, for example. The identifiers 202 need not be traceable by the resources to the requesting principal, thereby maintaining and securing the anonymity of the principal. The identifiers 202 can be encrypted or represented as assertions from the creation or identity service. These assertions are generally made by the creation or identity service and can vouch for the crafted identity. They can also be relied upon by the resources.

The policies 204 can also be created by a creation service or an identity service, such as the creation service 100 of FIGS. 1A-B. The policies can define limitations on access rights for given contexts that a principal may encounter when accessing a given resource, for example.

The roles and/or permissions 206 can define access rights for given roles that the crafted identity can assume with respect to accessing the resource. The definition of the roles and/or permissions 206 can be static and fully declared within the data structure 200 or, alternatively, it can be represented as a specification that is adapted to be dynamically resolved (e.g., at runtime) or when a specific access of a resource is made.

### Exemplary Predictive Service Systems

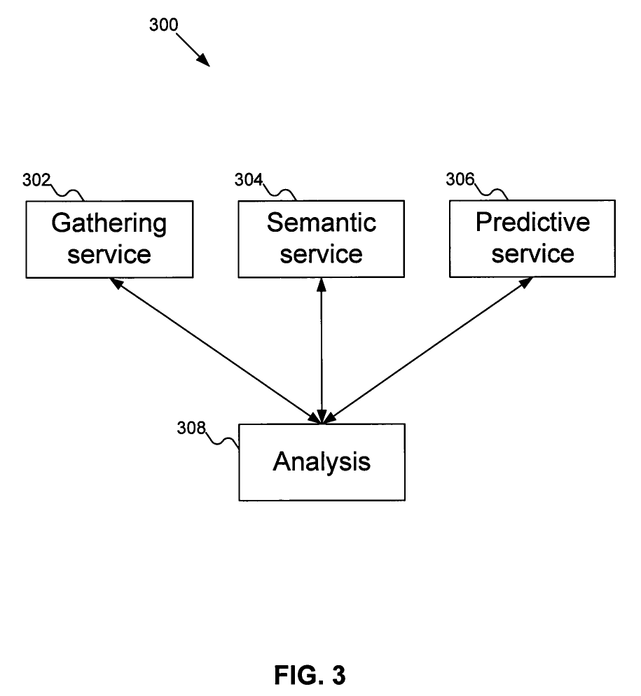

FIG. 3 shows an example of a predictive service system 300 that includes a gathering service 302, a semantic service 304, a predictive service 306, and an analysis module 308 in accordance with embodiments of the disclosed technology. One having ordinary skill in the art will recognize that the gathering service 302 can include one or more gathering services, the semantic service 304 can include one or more semantic services, and the predictive service 306 can include one or more predictive services. Each of the components illustrated in FIG. 3 are discussed in detail below.

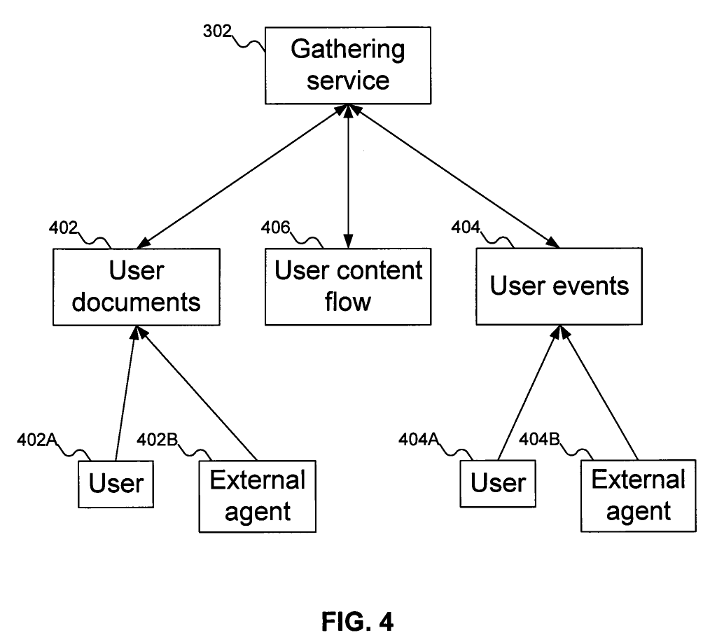

An example of the gathering service 302 is illustrated in FIG. 4, in which the gathering service 302 can interactively access and gather content, events, etc. from a wide variety of sources, such as user documents 402, user events 404, and user content flow 406. For example, each user of the system can have his or her own user documents 404 and user events 406.

User documents 402 can include Microsoft Office (e.g., Word and Excel) documents, e-mail messages and address books, HTML documents (e.g., that were downloaded by the user, intentionally or incidentally), and virtually anything in a readable file (e.g., managed by the user). User documents 402 can also include stored instant messaging (IM) data (e.g., IM sessions or transcripts), favorite lists (e.g., in an Internet browser), Internet browser history, weblinks, music files, image files, vector files, log files, etc.

User documents 402 can be directly controlled by a user 402A or added via one or more external agents 402B. As used herein, external agents generally refer to, but are not limited to, RSS feeds, spiders, and bots, for example.

User documents 402 can be stored in a document store that the user has access to and can manage. For example, user documents 402 can be stored locally (e.g., on a local disc or hard drive) or in a storage area that the user can access, manage, or subscribe to.

User events 404 can include a calendar item (e.g., something planned to occur at a particular time/place such as a meeting or a trip), a new category in a blog, or a user's blocking out of an entire week with a note stating that “I need to set up a meeting this week.” The simple fact that a blog was created or accessed can be a user event 404.

User events 404 can be directly controlled by a user 404A or added via one or more external agents 404B. The user 404A can be the same user 402A that controls the user events 402 or a different user. The external agent 404B can be the same external agent 402B (or same type of agent) that adds to the user events 402 or a different external agent entirely. An exemplary directly-controlled user event can include an appointment or “to-do” added in a calendar application (e.g., Microsoft Outlook). An exemplary event added by an external agent can include an appointment to the user's own calendar application from an event in an external calendar application (e.g., a meeting scheduled in another user's calendar application).

As used herein, user content flow 406 generally represents network or content traffic that moves events and/or content from one place to another, such as a user adding, deleting, or editing a user document 402, a user document 402 affecting another user document 402, or a user event 404 affecting one or more user documents 402, for example. User content flow 406 can also refer to a sequence of things that happen to one or more events and/or content as time progresses (such as a monitoring of TCP/IP traffic and other types of traffic into and/or out of the user's local file system, for example).

### Exemplary Gathering Services

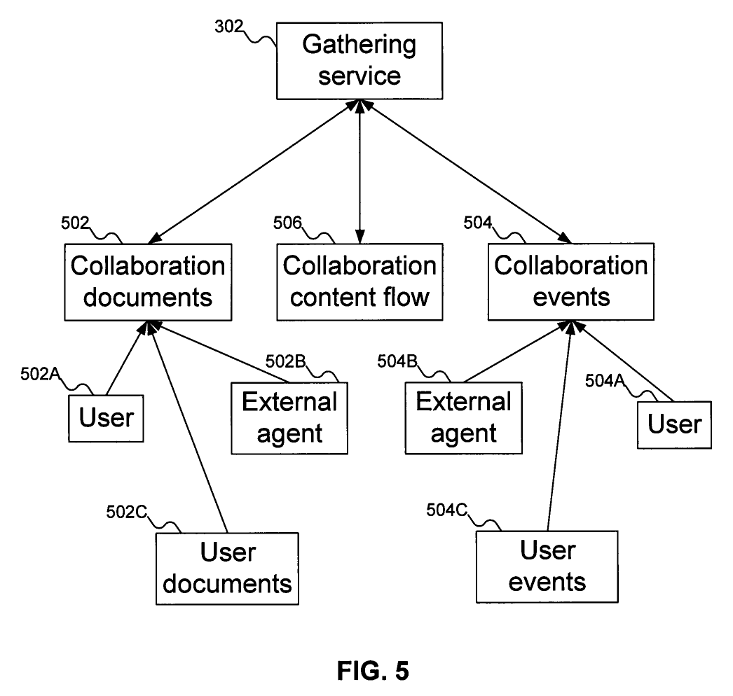

FIG. 5 illustrates that the gathering service 302 can also interactively access and gather content, events, etc. from collaboration documents 502, collaboration events 504, and collaboration content flow 506. Such interaction between the gathering service 302 and one or more of the collaboration components 502, 504, and 506 can occur concurrently with or separately from interaction between the gathering service 302 and one or more of the user components 402, 404, and 406 (as shown in FIG. 4). As used herein, a collaboration generally refers to a group of individual users.

Collaboration documents 502 can be directly controlled by a user or any number of members of a group or groups of users 502A or added via one or more external agents 502B. As discussed above, external agents generally refer to, but are not limited to, RSS feeds, spiders, and bots, for example. Collaboration documents 502 can include Microsoft Office (e.g., Word and Excel) documents, e-mail messages and address books, HTML documents (e.g., that were downloaded by the user, intentionally or incidentally), and virtually anything in a readable file. Collaboration documents 502 can also include stored instant messaging (IM) data (e.g., IM sessions or transcripts), favorite lists (e.g., in an Internet browser), Internet browser history, music files, image files, vector files, log files, etc. of one or more users. Collaboration documents 502 can also include, for example, the edit history of a wiki page.

Collaboration documents 502 can be stored in a document store that a particular user or members of a group or groups of users have access to and can manage. For example, collaboration documents 502 can be stored on a disc or hard drive local to a particular user or members of a group or groups of users or in a storage area that the user or member of the group or groups of users can access, manage, or subscribe to.

Collaboration events 504 can be directly controlled by a user or member of a group or groups of users 504A or added via one or more external agents 504B. The user or members of a group or groups of users 504A can be the same user or members 502A that control the collaboration events 502 or a different user or members. The external agent 504B can be the same external agent 502B (or same type of agent) that adds to the collaboration events 502 or a different external agent entirely. An exemplary directly-controlled user event can include an appointment or “to-do” added in a calendar application (e.g., Microsoft Outlook) shared by or accessible to a number of users. An exemplary event added by an external agent can include an appointment to the shared calendar application from an event in an external calendar application (e.g., a meeting scheduled in a different group's calendar application).

As used herein, collaboration content flow 506 generally represents network or content traffic that moves events and/or content from one place to another, such as a user or members of a group or groups adding, deleting, or editing a collaboration document 502, a collaboration document 502 affecting another collaboration document 502, or a collaboration event 504 affecting one or more collaboration documents 502, for example.

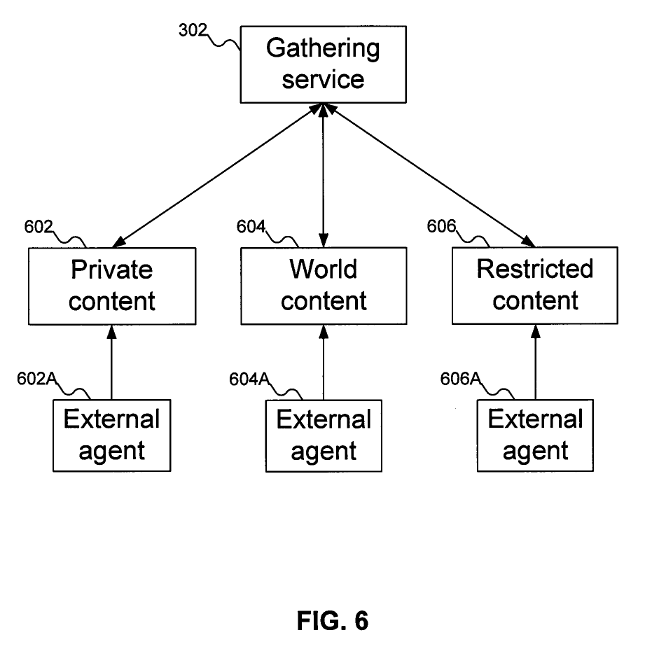

FIG. 6 illustrates that the gathering service 302 can also interactively access and gather content from private content 602, world content 604, and restricted content 606. Such interaction between the gathering service 302 and one or more of the private content 602, world content 604, and restricted content 606 can occur concurrently with or separately from interaction between the gathering service 302 and one or more of the user components 402, 404, and 406 (as shown in FIG. 4) and one or more of the collaboration components 502, 504, and 506 (as shown in FIG. 5).

As used herein, private content 602 generally refers to content under the control of a particular user that may be outside of the containment of user documents such as the user documents 402 of FIG. 4. The private content 602 is typically content that the user chooses to hold more closely and not make available to a gathering service (such as gathering service 302 in FIGS. 3-5), even in instances where one or more policy services manages access to the private content 602. One or more external agents 602A can provide input to the private content 602.

As used herein, world content 604 generally refers to content that is usually publicly available, such as Internet content that has no access controls. One or more external agents 604A can provide input to the world content 604.

As used herein, restricted content 606 generally refers to content that is provided to a user under some type of license or access control system. In certain embodiments, restricted content 606 is provided by an enterprise as content that is considered to be proprietary or secret to the enterprise, for example. Restricted content can also include content such as travel information pertaining to a travel service that the user has used (e.g., subscribed to) for actual or possible travel plans, for example. One or more external agents 606A can provide input to the restricted content 606.

With appropriate access permissions, embodiments of the disclosed technology can provide for one or more gathering services (e.g., gathering service 302 of FIGS. 3-6) that can access and gather content and/or events from virtually any combination of user documents, user events, user content flow, collaboration documents, collaboration events, collaboration content flow, private content, world content, and restricted content.

In an example, a user spends time on various Internet websites researching the Mars lander. In the scenario, the fact that the user is actively pursuing information pertaining to the Mars lander is information that a gathering service could gather. The gathering service could gather the information real-time or from a log (e.g., by watching actual content flow to decode HTML and find out what person is looking at) and a semantic service could semantically characterize the information.

In certain embodiments, a predictive services system includes a gathering service (such as gathering service 302 of FIGS. 3-6) that can update an analysis module (such as the analysis module 308 of FIG. 3). For example, the system can update a data repository used by the analysis module as new content and/or events are gathered. The system can also update the data repository as existing content and/or events are changed or deleted.

### Exemplary Multi-Dimensional Semantic Space

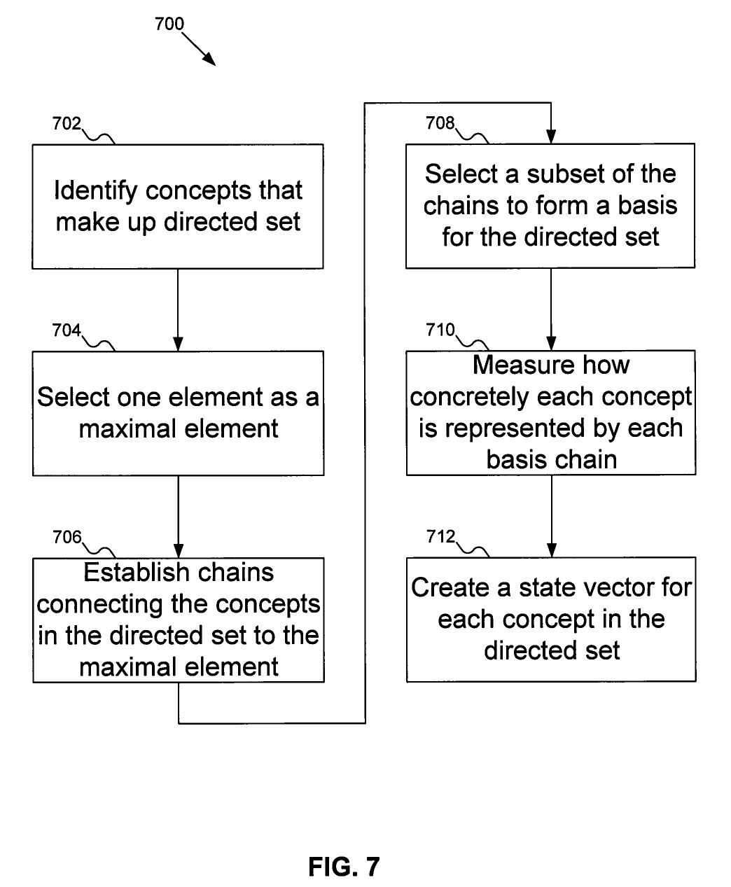

An example of constructing a semantic space can be explained with reference to FIG. 7, which shows a flowchart illustrating an example of a method 700 of constructing a directed set. At 702, the concepts that will form the basis for the semantic space are identified. These concepts can be determined according to a heuristic, or can be defined statically. At 704, one concept is selected as the maximal element.

At 706, chains are established from the maximal element to each concept in the directed set. There can be more than one chain from the maximal element to a concept: the directed set does not have to be a tree. Also, the chains generally represent a topology that allows the application of Uryshon's lemma to metrize the set. At 708, a subset of the chains is selected to form a basis for the directed set.

At 710, each concept is measured to see how concretely each basis chain represents the concept. Finally, at 712, a state vector is constructed for each concept, where the state vector includes as its coordinates the measurements of how concretely each basis chain represents the concept.

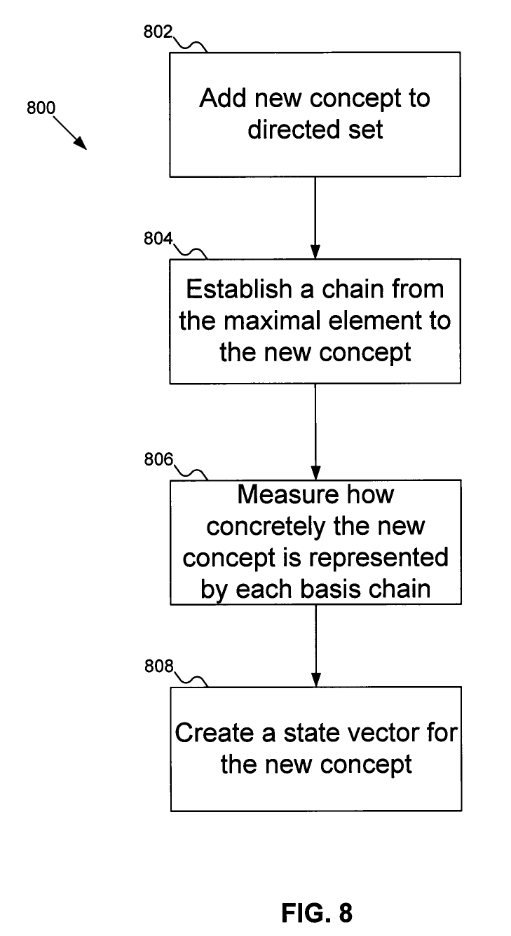

FIG. 8 shows a flowchart illustrating an example of a method 800 of adding a new concept to an existing directed set. At 802, the new concept is added to the directed set. The new concept can be learned by any number of different means. For example, the administrator of the directed set can define the new concept. Alternatively, the new concept can be learned by listening to a content stream. One having ordinary skill in the art will recognize that the new concept can be learned in other ways as well. The new concept can be a “leaf concept” (e.g., one that is not an abstraction of further concepts) or an “intermediate concept” (e.g., one that is an abstraction of further concepts).

At 804, a chain is established from the maximal element to the new concept. Determining the appropriate chain to establish to the new concept can be done manually or based on properties of the new concept learned by the system. One having ordinary skill in the art will also recognize that more than one chain to the new concept can be established.

At 806, the new concept is measured to see how concretely each chain in the basis represents the new concept. Finally, at 808, a state vector is created for the new concept, where the state vector includes as its coordinates the measurements of how concretely each basis chain represents the new concept.

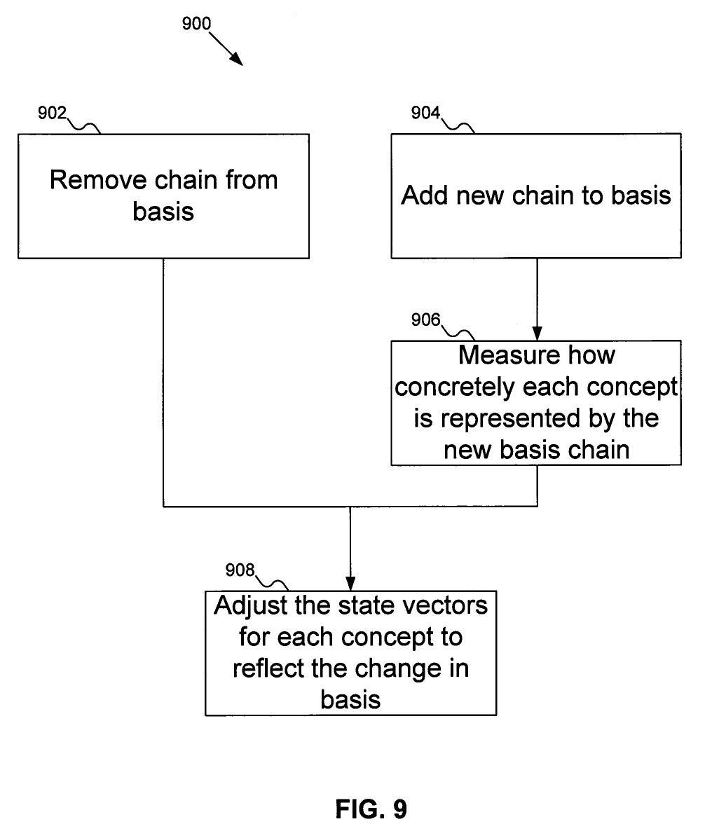

FIG. 9 shows a flowchart illustrating an example of a method 900 of updating the basis, either by adding to or removing from the basis chains. If chains are to be removed from the basis, then the chains to be removed are deleted, as shown at 902. Otherwise, new chains are added to the basis, as shown at 904. If a new chain is added to the basis, each concept must be measured to see how concretely the new basis chain represents the concept, as shown at 906. Finally, whether chains are being added to or removed from the basis, the state vectors for each concept in the directed set are updated to reflect the change, as shown at 908.

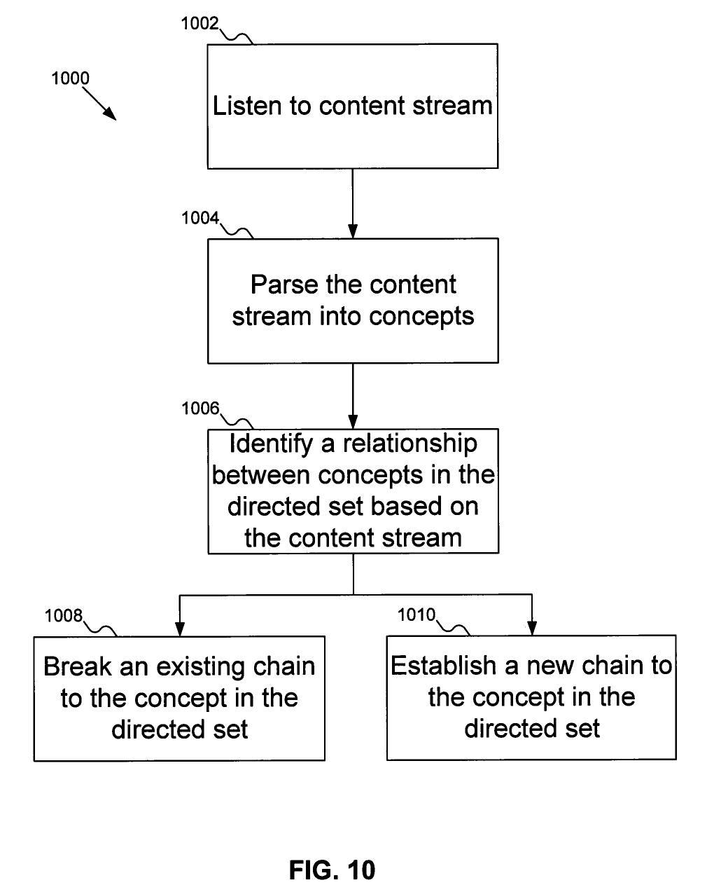

FIG. 10 shows a flowchart illustrating an example of a method 1000 of updating the directed set. At 1002, the system is listening to a content stream. At 1004, the system parses the content stream into concepts. At 1006, the system identifies relationships between concepts in the directed set that are described by the content stream. Then, if the relationship identified at 1006 indicates that an existing chain is incorrect, the existing chain is broken, as shown at 1008. Alternatively, if the relationship identified at 1006 indicates that a new chain is needed, a new chain is established, as shown at 1010.

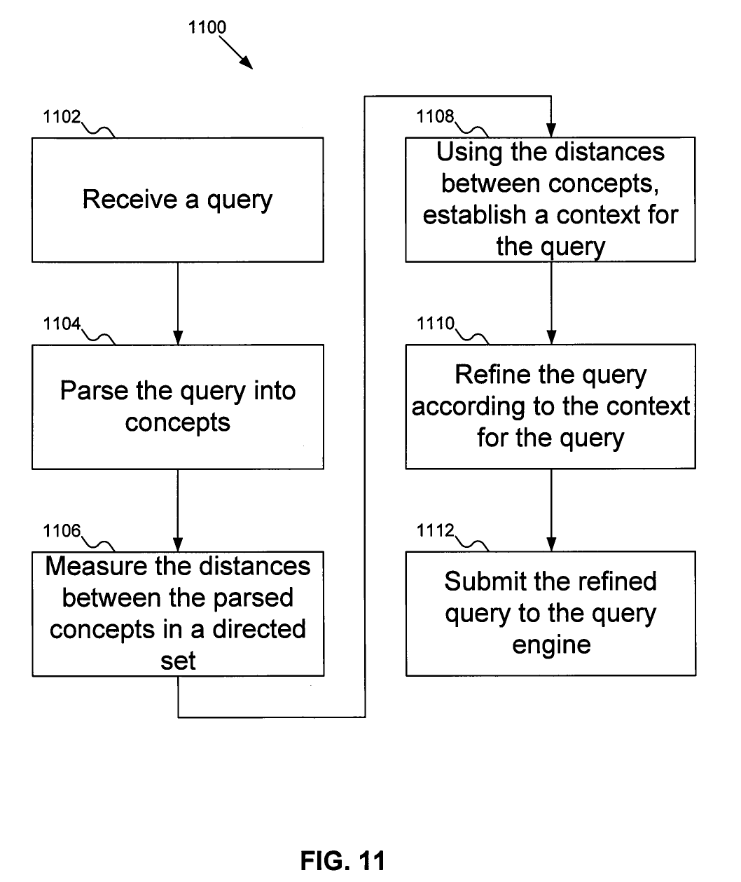

FIG. 11 shows a flowchart illustrating an example of a method 1100 of using a directed set to refine a query (such as to a database, for example). At 1102, the system receives the query. At 1104, the system parses the query into concepts. At 1106, the distances between the parsed concepts are measured in a directed set. At 1108, using the distances between the parsed concepts, a context is established in which to refine the query. At 1110, the query is refined according to the context. Finally, at 1112, the refined query is submitted to the query engine.

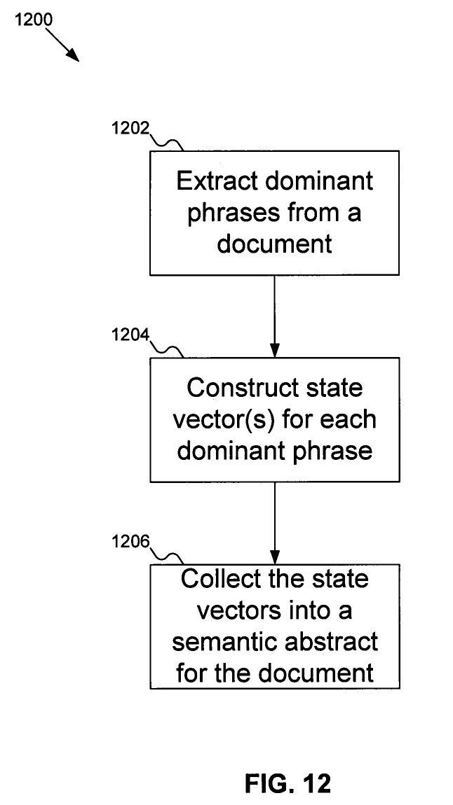

FIG. 12 shows a flowchart illustrating an example of a method 1200 of constructing a semantic abstract for a document based on dominant phrase vectors. At 1202, phrases (the dominant phrases) are extracted from the document. The phrases can be extracted from the document using a phrase extractor, for example. At 1204, state vectors (the dominant phrase vectors) are constructed for each phrase extracted from the document. One having ordinary skill in the art will recognize that there can be more than one state vector for each dominant phrase. At 1206, the state vectors are collected into a semantic abstract for the document.

Phrase extraction can generally be done at any time before the dominant phrase vectors are generated. For example, phrase extraction can be done when an author generates the document. In fact, once the dominant phrases have been extracted from the document, creating the dominant phrase vectors does not require access to the document at all. If the dominant phrases are provided, the dominant phrase vectors can be constructed without any access to the original document.

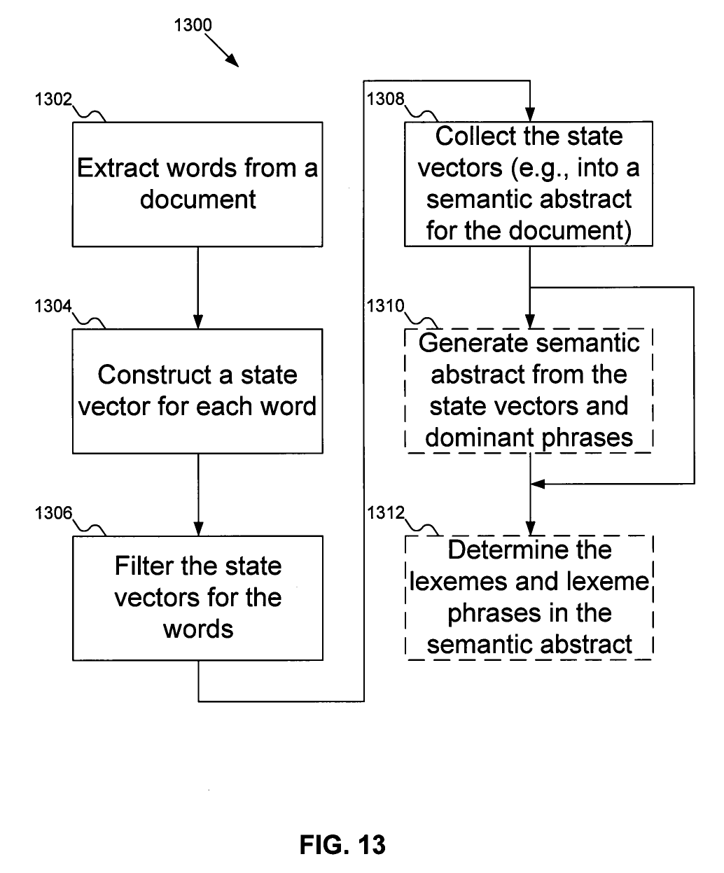

FIG. 13 shows a flowchart illustrating an example of a method 1300 of constructing a semantic abstract for a document based on dominant vectors. At 1302, words are extracted from the document. The words can be extracted from the entire document or from only portions of the document (such as one of the abstracts of the document or the topic sentences of the document, for example). At 1304, a state vector is constructed for each word extracted from the document. At 1306, the state vectors are filtered to reduce the size of the resulting set, producing the dominant vectors. Finally, at 1308, the filtered state vectors are collected into a semantic abstract for the document.

FIG. 13 shows two additional steps that are also possible in the example. At 1310, the semantic abstract is generated from both the dominant vectors and the dominant phrase vectors. The semantic abstract can be generated by filtering the dominant vectors based on the dominant phrase vectors, by filtering the dominant phrase vectors based on the dominant vectors, or by combining the dominant vectors and the dominant phrase vectors in some way, for example. Finally, at 1312, the lexeme and lexeme phrases corresponding to the state vectors in the semantic abstract are determined.

As discussed above regarding phrase extraction in FIG. 12, the dominant vectors and the dominant phrase vectors can be generated at any time before the semantic abstract is created. Once the dominant vectors and dominant phrase vectors are created, the original document is not necessarily required to construct the semantic abstract.

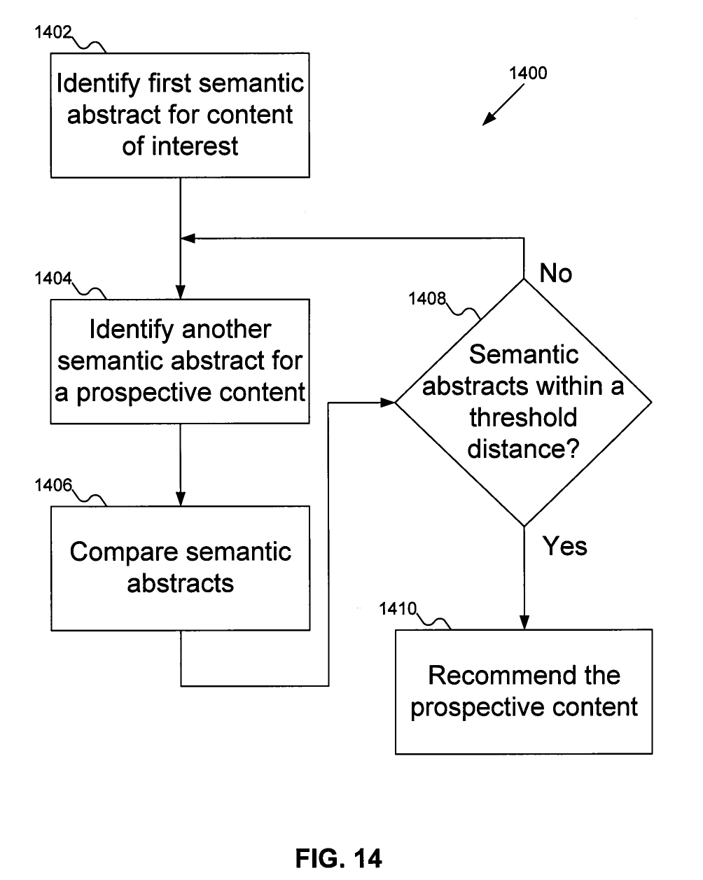

FIG. 14 shows a flowchart illustrating an example of a method 1400 of comparing two semantic abstracts and recommending a second content that is semantically similar to a content of interest. At 1402, a semantic abstract for a content of interest is identified. At 1404, another semantic abstract representing a prospective content is identified. In either or both 1402 and 1404, identifying the semantic abstract can include generating the semantic abstracts from the content, if appropriate. At 1406, the semantic abstracts are compared. Next, a determination is made as to whether the semantic abstracts are “close,” as shown at 1408. In the example, a threshold distance is used to determine if the semantic abstracts are “close.” However, one having ordinary skill in the art will recognize that there are various other ways in which two semantic abstracts can be deemed “close.”

If the semantic abstracts are within the threshold distance, then the second content is recommended to the user on the basis of being semantically similar to the first content of interest, as shown at 1410. If the other semantic abstracts is not within the threshold distance of the first semantic abstract, however, then the process returns to step 1404, where yet another semantic abstract is identified for another prospective content. Alternatively, if no other content can be located that is “close” to the content of interest, processing can end.

In certain embodiments, the exemplary method 1400 can be performed for multiple prospective contents at the same time. In the present example, all prospective contents corresponding to semantic abstracts within the threshold distance of the first semantic abstract can be recommended to the user. Alternatively, the content recommender can also recommend the prospective content with the semantic abstract nearest to the first semantic abstract.

### Exemplary Predictive Services

Semantic processing of content (e.g., performed by one or more semantic services such as the semantic service 304 of FIG. 3) can be used in conjunction with an analysis module (such as the analysis module 308 of FIG. 3) to provide one or more predictive services (such as the predictive service 306 of FIG. 3) with actionable analysis. In certain embodiments, the type of content processed can be used in determining which predictive service to invoke.

Based on the analysis provided by the analysis module, the predictive service can determine and provide correlated hints, suggestions, content change, events, prompts, etc. to a user or group of users (e.g., a collaboration group). The predictive service can be set to automatically take action on the hints, suggestions, etc., or to recommend to a user or collaboration that the hint or suggestion should be acted on [and then wait for a response from the user or collaboration].

Described below are several detailed examples (user scenarios) of implementations of predictive service systems.

### Exemplary Preferences

A user can provide a set of preferences for items that the user feels are pertinent and that he or she feels comfortable sharing with a predictive service system. For example, preferences can include colors, preferred times for meetings, preferred hotels and/or restaurants, preferred ways to be contacted, etc. Preferences can also include a likability rating for specific events, people, and things. For example, if a likability scale ranges from 1 to 10 (with 10 being the highest likability rating), a user may rate going to the Opera as a 8 but rate going to a rodeo as a 1.

While preferences can be declared by a user (e.g., the user may declare that the likability of going to the Opera is a 10), the preferences can be modified by either the user or a predictive service system over time. For example, after attending an event, the predictive service system can create an event to request an evaluation of the attended event so that the likability rating for the type of event can be updated. Thus, preferences can be modified in virtually real-time and in a way that is very natural to the user.

A predictive service system can also modify user preferences based on indirect input from the user (e.g., from any number of user and collaboration events, documents, and content flow, and private, world, and restricted content). For example, even though a user may claim to like Opera (via a high likability rating), information from the user's blog postings may show that the user often provides negative feedback for new Operas. A semantic service can analyze the data to provide updated preference information to the predictive service system that the user likes new Operas less than traditional Operas. Thus, the predictive service system can refine the user's preferences based on information gleaned from various sources, thereby allowing the predictive service system to “learn” what the user likes, wants, and desires.

In another example, even though a user may indicate via his or her preferences that he or she prefers to start the day at 8:00 a.m., the number of times the user is late for meetings, appointments, and breakfast reservations suggests that the user really prefers to start the day at 9:00 a.m. A semantic service can analyze the behavior of the user to determine that a change is needed, and the predictive service system can automatically adjust the preferences for the user. Thus, the predictive service system has again “learned” what the user likes, wants, and desires without any direct input by the user. In some cases, such analysis may even suggest preferences that are exactly opposite to what the user would state for themselves.

A predictive service system can also make predictions based on preferences from other users. In such situations, a predictive service system can use similarities between users to determine possible preferences for a first user that had heretofore perhaps not even been considered by the first user. For example, the predictive service system can receive intelligence that many users who enjoy traditional Operas also enjoy horseback riding and travel to Peru. Such intelligence would then be used by the predictive service system to suggest these activities to the first user, whose reaction would then provide additional preference information for the user and, if allowed by policy, preference information that could be contributed back to further refine the externally-provided preference.

Externally-provided preferences can be provided within an enterprise for their employees (and only cover matters that are of interest to the company, for example) by specific preference monitoring services that a user could choose to subscribe to, and/or by global preference services providing free information. Information can be gathered according to policy, anonymized, and correlated to provide possible preferences and recommendations based on similarities. Also, a policy decision point (PDP) can be used to filter what content/events are allowed or not allowed based on a policy, for example.

Preference information can be gathered by using a directed questionnaire. For example, a weighted vector could be created in situations where a user supplies weight-related information (e.g., “I am 100% positive of this recommendation”). The user can also provide preference information directly. However, certain information (e.g., that the user likes Operas prior to 1820) does not provide enough detail for a semantic abstract to be created, so such information is typically stored parametrically. If the user provides information indicating that he or she likes books about a certain topic, however, such information can be used to create a semantic abstract (e.g., by a semantic service).

In certain embodiments, preference information can include negative language (e.g., things that a user does not like). In those situations, whatever semantic abstracts are created are placed in a space other than that in which positive-language semantic abstracts are placed.

Exemplary User Scenarios in Accordance with Implementations of the Disclosed Technology

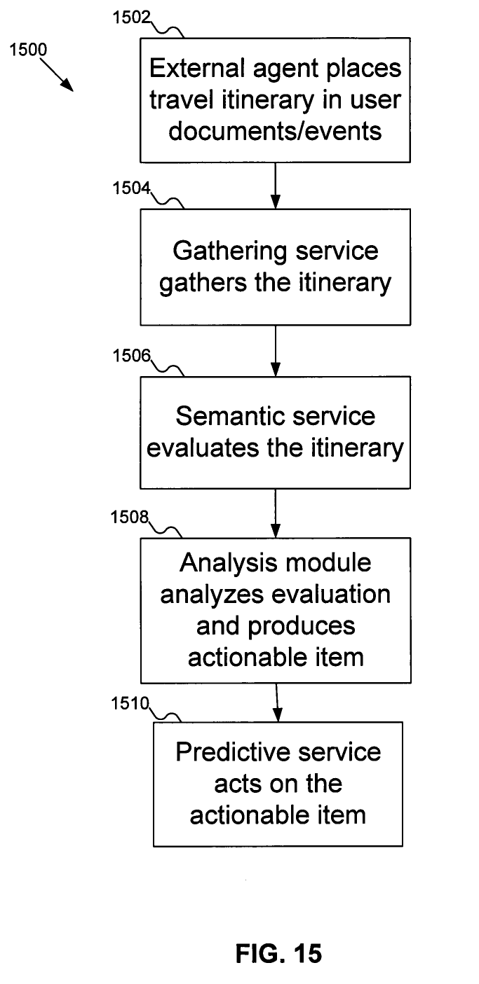

FIG. 15 illustrates a user scenario 1500, in which a user receives a notification of a travel itinerary received into the user's user documents (e.g., as an e-mail) via an external agent, as shown at 1502. The external agent can also place the travel itinerary in the user's user events. At 1504, a gathering service obtains the itinerary from the user documents and/or events. At 1506, a semantic service evaluates the itinerary. At 1508, an analysis module receives an evaluation from the semantic service and produces at least one actionable analysis item such as travel taking place on a certain date, flights lasting a certain amount of time, connections being made through specific airports, etc.

At 1510, a predictive service acts on the actionable analysis item produced by the analysis module. In the example, the actionable analysis item indicates that a storm is anticipated for the day that the user would need to travel to the airport. Thus, the predictive service can block out time on the user's calendar to provide the user with sufficient time to travel to the airport based on the type of storm that is due, the security check, and anything else that will be required for the user. The predictive service can notify the user that the “travel to the airport” event has been provided and that the user can then interact with the event, if desired.

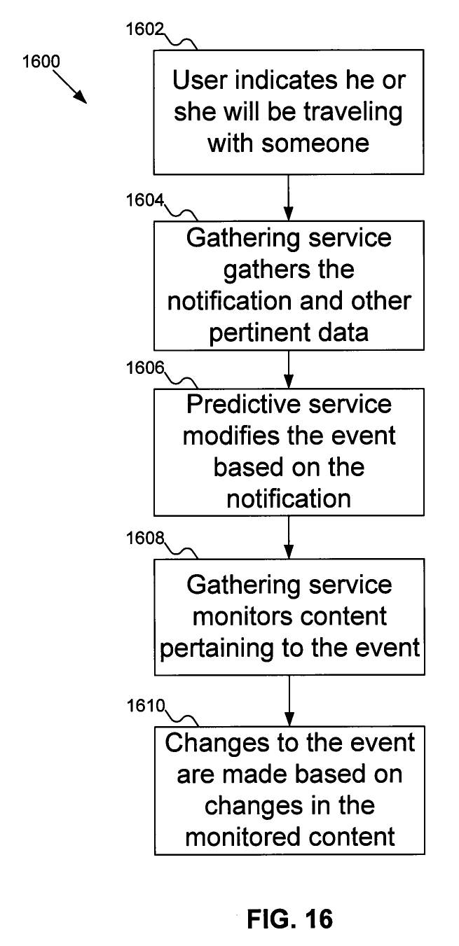

FIG. 16 illustrates a user scenario 1600, in which an itinerary (e.g., the itinerary from the example illustrated in FIG. 15) has been previously established for a user. At some point after a “travel to the airport” event has been provided, the user indicates to a predictive service system (e.g., via a user event) that the user will be traveling to the airport with another person, as shown at 1602. A gathering service then can gather the notification as well as any events in the other user's calendar that may pertain to the “travel to the airport” event, as shown at 1604. A predictive service can change the event to take into account extra time needed to stop and pick up the second person, as shown at 1606. One having ordinary skill in the art will recognize that virtually any changes to the event can be similarly correlated between participants.

At this point, the planned trip has now been updated based on the change in plans and the gathering service can regularly access restricted content or world content, for example, to perform tasks such as tracking the anticipated flight schedule, as shown at 1608. Any subsequent changes to the event (e.g., changes in flight time, weather report, security check-in procedures, or number of passengers) can thus be reflected (in some cases, immediately) in the pertinent user's events, and appropriate changes to related events can be made, as shown at 1610.

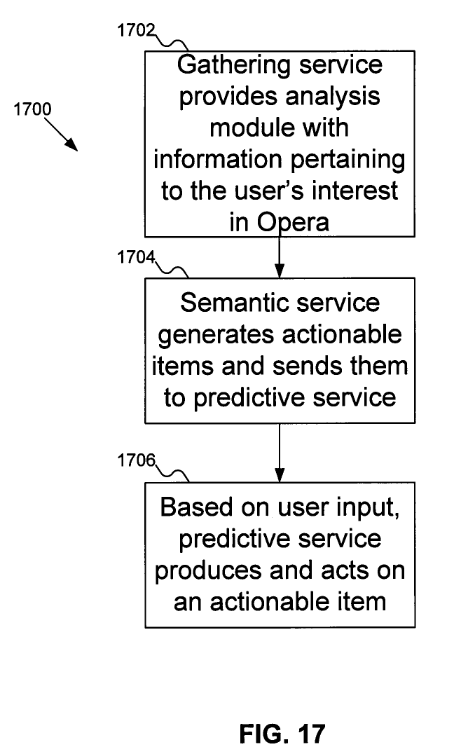

FIG. 17 illustrates a user scenario 1700, in which a predictive service system includes a gathering service that, having accessed a user's private content, provides an analysis module with a notification that a user enjoys the Opera and that, on other visits to one of the cities in the user's itinerary (e.g., the itinerary from the example illustrated in FIG. 15), the user had stopped and taken time to visit the Opera, as shown at 1702. For example, the gathering service can gather information indicating which Operas (if any) the user has attended within a certain amount of time (e.g., within the past five years).

At 1704, a semantic service can generate actionable items. At 1706, a predictive service can act on the actionable items by suggesting to the user (e.g., in the user's events) that tickets to certain Opera performances are available for purchase and also by providing the price of those tickets to the user, for example.

By interacting with this event, the user can select a desired Opera and the predictive service system can produce an actionable item, as shown at 1708. For example, if the user has a trip itinerary in his or her user events, the predictive service system can purchase the tickets to the Opera and make arrangements for the tickets to arrive at the hotel where the user will be staying. The system can also notify the hotel to have the tickets placed in the user's room, schedule a taxi to take the user to the Opera, and make dinner reservations for a time after the Opera is scheduled to finish at the user's favorite restaurant (e.g., based on preferences pertaining to any of the user's past trips as well as information in the user's user documents and private content).

In scenarios where a semantic service correlates a user's trip with the gathering of a collaboration group that the user works with (e.g., via the user scheduling the gathering or the system discovering the meeting based on a correlation between a notice in the user documents and/or collaboration documents and an event from collaboration events), various types of actionable items can be generated and acted upon by a predictive service system. Thus, such a system can ensure that the user's planned meetings, meals, hotel rooms, etc., will be recommended and possibly even secured for the user.

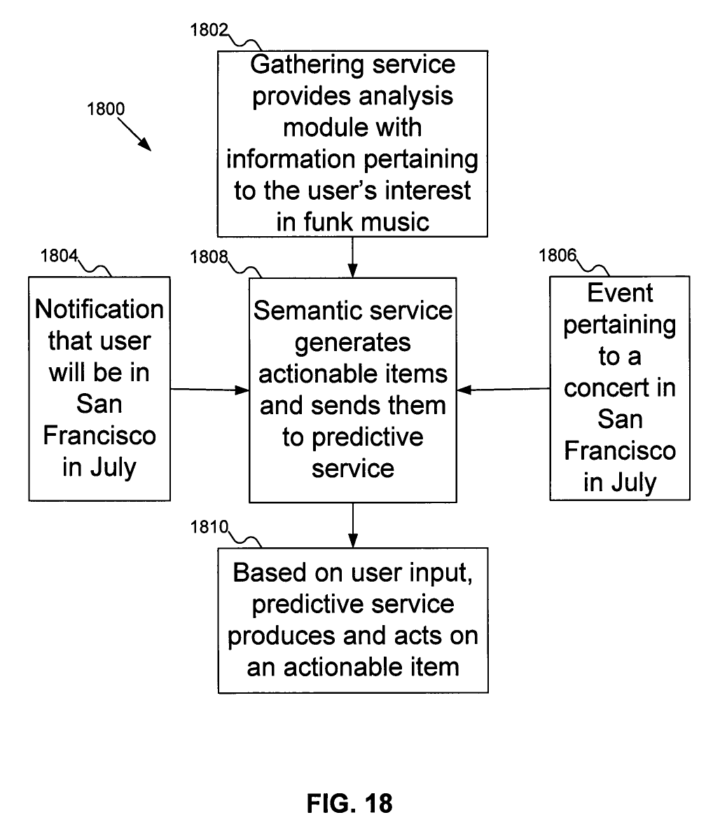

FIG. 18 illustrates a user scenario 1800, in which a predictive service system includes a gathering service that, having accessed a user's private content, provides an analysis module with a notification that a user enjoys 70's funk music (e.g., because of Internet radios stations the user has listened to and music the user has downloaded to Rhapsody or iTunes, for example), as shown at 1802. The predictive service system can also provide or acknowledge a notification (e.g., by the user directly or by an external agent) that the user will be traveling to San Francisco in July, as shown at 1804.

An external agent can create an event including information that there is an Earth, Wind, and Fire concert scheduled for San Francisco in July, as shown at 1806. A semantic service can generate actionable items, as shown at 1808. A predictive service can act on the actionable items, as shown at 1810, by suggesting to the user (e.g., in the user's events) that certain operating events are available and that tickets to the Earth, Wind, and Fire concert may be purchased. The system can also provide the user with the current price of the tickets.

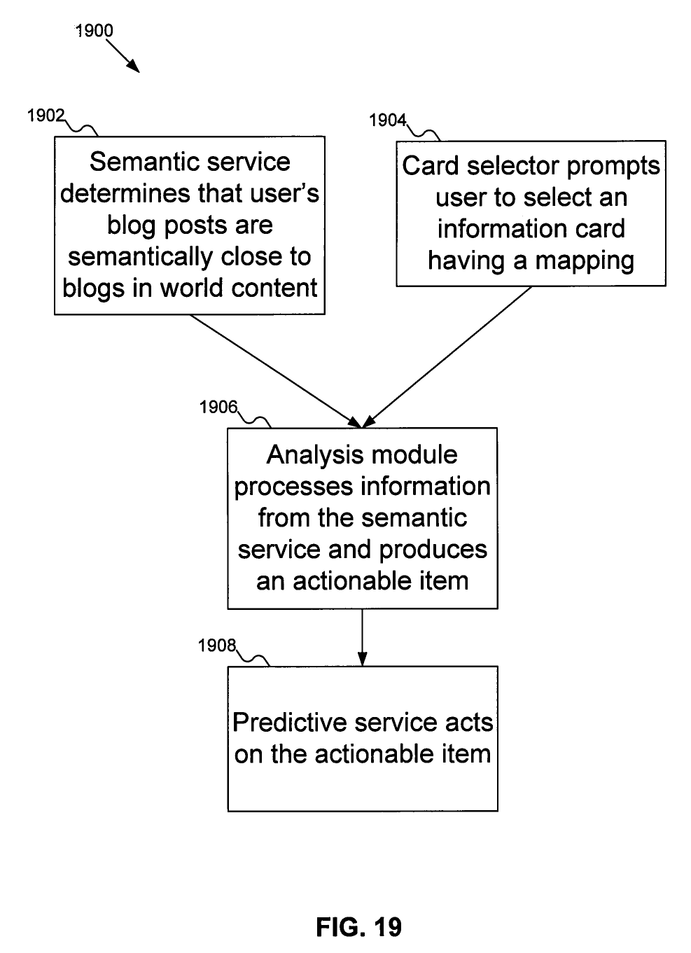

FIG. 19 illustrates a user scenario 1900, in which user has three blogs: one in private content, one in restricted content, and one in world content. A semantic service can determine that recent posts in the restricted blog on Virtualization are semantically close to other blogs in world content, as shown at 1902. The semantic service can also determine that there is a conference coming up on Virtualization, as shown at 1904.

At 1906, an analysis module processes information from the semantic service and produces an actionable item. At 1908, a predictive service acts on the actionable item by suggesting to the user that, if the user were to move his or her recent postings on the restricted blog to the world blog, then the user might be able to expect an invitation to speak at the conference or, alternatively, submit a paper based on previously-blogged reports.

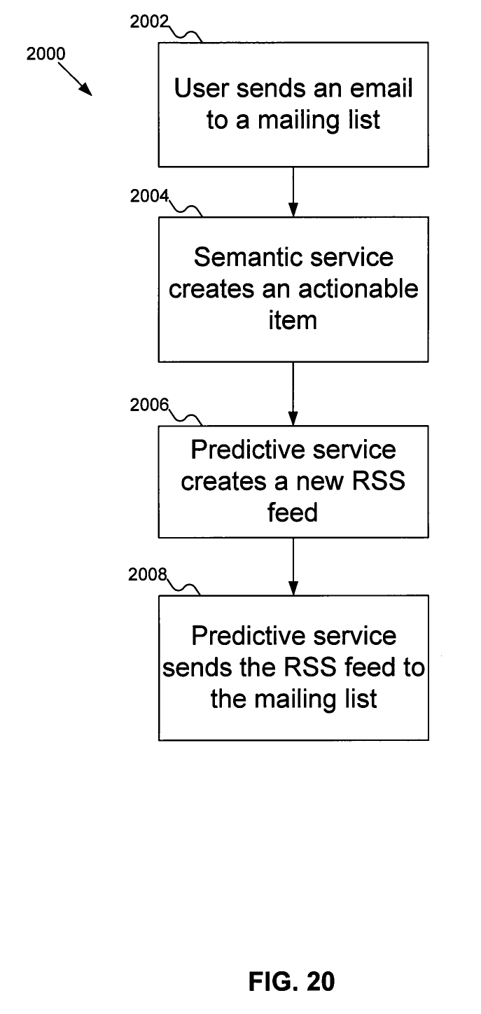

FIG. 20 illustrates a user scenario 2000, in which a user sends an email summarizing recent trends on unified collaboration to a mailing list that is designated for the “sharing of information about unified collaboration,” as shown at 2002. A semantic service can create an actionable item, as shown at 2004, and a predictive service can act on the actionable item. For example, the predictive service can create a new RSS feed on unified collaboration and format an email with links and stories (e.g., using a boilerplate template) for the user to make comments on, as shown at 2006. The predictive service can then send out the RSS feed to the mailing list, as shown at 2008.

One having ordinary skill in the art will recognize that there is a wide variety of potential user scenarios. For example, consider a user that needs to create accounts on different websites as needed in order to broker services for the user, for example. In such situations, the user would not need to fill out the “create account” web page at each website because a predictive service system can utilize a gathering service, a semantic service, and a predictive service to identify which websites require a new account, gather the user's information, and automatically fill out the “create account” web page for each site.

In an exemplary collaboration scenario, a collaboration group creates a calendar item requesting that the group go out to dinner together. In the example, a predictive service system can gather information pertaining to the eating preferences of each user in the collaboration (e.g., by accessing user and/or collaboration content), gather information pertaining to different restaurants in area (e.g., by accessing world content), and gather risk-assessment-type information (e.g., which restaurants require reservations). The information can be correlated and analyzed, and a predictive service can provide a list of dining options to the collaboration. Alternatively, the predictive service system could be set to automatically make (or attempt to make) a reservation to a particular restaurant (e.g., the one with the highest correlation value based on the gathered information).

In certain embodiments, a predictive service system can have a confidence level with respect to certain types of information. In one example, the system determines that a user might like to see a particular Opera. If the system has a high confidence level that the user would like the Opera, the service can automatically order tickets for the performance. If the confidence level is not as high, the system can alternatively inform the user of the Opera and ask the user certain questions to determine whether to add the Opera to the user's preferences, for example, for future reference.

General Description of a Suitable Machine in which Embodiments of the Disclosed Technology can be Implemented

The following discussion is intended to provide a brief, general description of a suitable machine in which embodiments of the disclosed technology can be implemented. As used herein, the term “machine” is intended to broadly encompass a single machine or a system of communicatively coupled machines or devices operating together. Exemplary machines can include computing devices such as personal computers, workstations, servers, portable computers, handheld devices, tablet devices, and the like.

Typically, a machine includes a system bus to which processors, memory (e.g., random access memory (RAM), read-only memory (ROM), and other state-preserving medium), storage devices, a video interface, and input/output interface ports can be attached. The machine can also include embedded controllers such as programmable or non-programmable logic devices or arrays, Application Specific Integrated Circuits, embedded computers, smart cards, and the like. The machine can be controlled, at least in part, by input from conventional input devices (e.g., keyboards and mice), as well as by directives received from another machine, interaction with a virtual reality (VR) environment, biometric feedback, or other input signal.

The machine can utilize one or more connections to one or more remote machines, such as through a network interface, modem, or other communicative coupling. Machines can be interconnected by way of a physical and/or logical network, such as an intranet, the Internet, local area networks, wide area networks, etc. One having ordinary skill in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

Embodiments of the disclosed technology can be described by reference to or in conjunction with associated data including functions, procedures, data structures, application programs, instructions, etc. that, when accessed by a machine, can result in the machine performing tasks or defining abstract data types or low-level hardware contexts. Associated data can be stored in, for example, volatile and/or non-volatile memory (e.g., RAM and ROM) or in other storage devices and their associated storage media, which can include hard-drives, floppy-disks, optical storage, tapes, flash memory, memory sticks, digital video disks, biological storage, and other tangible, physical storage media.

Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. A predictive service system, comprising:
at least one gathering service operable to gather user information pertaining to at least one user;
at least one semantic service operable to generate at least one semantic abstract for the user information;
at least one policy service operable to enforce at least one policy; and
at least one predictive service operable to act on at least one actionable item based at least in part on the user information, the at least one semantic abstract, and the at least one policy.

2. The predictive service system of claim 1, further comprising an analysis module in communication with the at least one gathering service, the at least one semantic service, and the at least one predictive service, wherein the analysis module is operable to create the at least one actionable item and send the at least one actionable item to the at least one predictive service.

3. The predictive service system of claim 1, further comprising at least one identity service operable to create a crafted identity for the user, wherein the at least one actionable item is based at least in part on the crafted identity.

4. The predictive service system of claim 1, wherein the user information comprises at least one of a user document and a user event.

5. The predictive service system of claim 1, wherein the user information comprises information pertaining to a user content flow.

6. The predictive service system of claim 1, wherein the user information comprises collaboration information pertaining to a collaboration group.

7. The predictive service system of claim 6, wherein the information pertaining to the collaboration group comprises at least one of a collaboration document and a collaboration event.

8. The predictive service system of claim 6, wherein the information pertaining to the collaboration group comprises information pertaining to a collaboration content flow.

9. The predictive service system of claim 1, wherein the at least one actionable item comprises at least one of a user recommendation, a user suggestion, and a user tip.

10. The predictive service system of claim 1, wherein the at least one actionable item comprises a creation of an RSS feed.

11. The predictive service system of claim 1, wherein the at least one actionable item comprises a creation of a travel itinerary.

12. The predictive service system of claim 1, wherein the at least one actionable item comprises at least one modification to an existing travel itinerary.

13. The predictive service system of claim 1, wherein the user information comprises at least one parametric user preference.

14. The predictive service system of claim 13, wherein the at least one actionable item is based at least in part on the at least one parametric user preference.

15. A computer-implemented method, comprising:
gathering user information from at least one source;
creating at least one semantic abstract corresponding to the user information;
correlating the at least one semantic abstract with at least one of a user identity and a policy; and
creating at least one actionable item based at least in part on the correlating.

16. The computer-implemented method of claim 15, wherein the at least one source comprises at least one of a user document and a user event.

17. The computer-implemented method of claim 15, wherein the at least one source comprises at least one of a collaboration document and a collaboration event.

18. The computer-implemented method of claim 15, wherein the at least one source comprises at least one of private content, world content, and restricted content.

19. The computer-implemented method of claim 15, further comprising automatically executing the at least one actionable item.

20. The computer-implemented method of claim 15, further comprising prompting the user for direction regarding execution of the at least one actionable item.

21. The computer-implemented method of claim 15, wherein creating the at least one actionable item comprises creating a new calendar event in a user calendar application.

22. The computer-implemented method of claim 15, wherein creating the at least one actionable item comprises modifying an existing calendar event in a user calendar application.

23. The computer-implemented method of claim 15, wherein the user information comprises at least one user preference.

24. The computer-implemented method of claim 15, wherein the at least one actionable item is based at least in part on a prediction confidence level.

25. The computer-implemented method of claim 15, further comprising narrowing the at least one actionable item based at least in part on at least one parametric user preference.

26. The computer-implemented method of claim 25, wherein the at least one parametric user preference corresponds to a positive user preference.

27. The computer-implemented method of claim 25, wherein the at least one parametric user preference corresponds to a negative user preference.

28. A system, comprising:
an identity module to manage an identity for a user;
a policy module to manage a policy;
a gathering module to gather user information;
a semantic module to create a semantic abstract based at least in part on the user information; and
an analysis module to generate an output based at least in part on a correlation of at least two of the identity, the policy, the user information, and the semantic abstract.

29. The system of claim 28, further comprising a predictive service module to implement the output from the analysis module.

30. The system of claim 28, wherein the predictive service module implements the output by providing the user with a recommendation.

31. The system of claim 28, further comprising an external agent to modify the user information.
